(19) United States
(12) Patent Application Publication
(10) Pub. No.: US 2026/0088846 A1
(43) Pub. Date: Mar. 26, 2026

(54) SIGNAL CLASSIFICATION USING RADIO FREQUENCY MACHINE LEARNING OF INTERFERENCE IN CONTESTED SPECTRUM ENVIRONMENTS

(71) Applicant: A10 Systems Inc d/b/a AiRANACULUS, Lowell, MA (US)

(72) Inventors: Dukhyun KIM, Keller, TX (US); Bryan CROMPTON, Lowell, MA (US); Matthew BROMBERG, Falls Church, VA (US); Apurva N. MODY, Chelmsford, MA (US)

(21) Appl. No.: 19/341,476

(22) Filed: Sep. 26, 2025

Related U.S. Application Data
(60) Provisional application No. 63/699,455, filed on Sep. 26, 2024.

(51) Int. Cl. H04B 1/10; G01S 19/21; G06F 18/213

(52) U.S. Cl. CPC H04B 1/1027; G01S 19/215; G06F 18/213

(57) ABSTRACT

In one aspect, a radio receive includes one or more antennas configured to receive a signal, wherein the signal includes an intended signal sent for reception by the radio receiver and one or more interfering signals. The radio receiver further includes one or more memories configured to store computer-readable instructions; and one or more processors. The one or more processors are configured to execute the computer-readable instructions to apply, in real-time, a first signal processing procedure to the signal to classify a corresponding type for each of the one or more interfering signals; determine an interference mitigation scheme for each type of interfering signal; apply, in real-time, a second signal processing procedure to the signal to mitigate the one or more interfering signals using the interference mitigation scheme for each type of interfering signal; and output the intended signal.

### CROSS-REFERENCE TO RELATED APPLICATIONS

This application claims priority to U.S. Provisional Application No. 63/699,455 filed on Sep. 26, 2025, the entire content of which is incorporated herein by reference.

### BACKGROUND

Wireless broadband represents a critical component of economic growth, job creation, and Global competitiveness because consumers are increasingly using wireless broadband services to assist them in their everyday lives. Demand for wireless broadband services and the network capacity associated with those services is surging, resulting in the development of a variety of systems and architectures that can meet this demand.

In a crowded airspace, where different signals are transmitted simultaneously over the same and/or overlapping channels, separating desired signals at a given receiver device from unwanted interfering signals is an ever-present challenge that continuously evolves due to evolving and complex nature of technologies used to transmit signals. Solutions to address these complex challenges should evolve and meet this challenge adequately.

### BRIEF SUMMARY

Aspects of the present disclosure are directed to real-time and intelligent signal classification techniques in a Radio Frequency (RF) environment, in which multiple sources transmit various types of RF signals. Any one or more of such signals may be intended for reception by one or more receivers while other signals may operate as interfering signals (known or unknown). This signal classification technique is a s multi-pronged approach to RF sensing and signal detection and characterization. The proposed technique includes statistical signal processing (e.g. Cyclostationary Signal Processing (CSP)), RF machine learning, multimodal fusion, and/or image processing for detection and characterization of wide variety of interferers. These techniques are combined with Cross Layer Sensing (CLS) statistics from a radio or a receiver to enhance the detection and characterization performance.

In one example, a method includes receiving, at a radio receiver, a signal, wherein the signal includes an intended signal sent for reception by the radio receiver and one or more interfering signals; applying, in real-time, a first signal processing procedure to the signal to classify a corresponding type for each of the one or more interfering signals; determining an interference mitigation scheme for each type of interfering signal; applying, in real-time, a second signal processing procedure to the signal to mitigate the one or more interfering signals using the interference mitigation scheme for each type of interfering signal; and outputting the intended signal.

In another aspect, the first signal processing procedure and the second signal processing procedure are applied to the signal, simultaneously.

In another aspect, the first signal processing procedure is applied to the signal first, prior to the second signal processing procedure being applied.

In another aspect, the first signal processing procedure includes performing a preliminary identification of the one or more interfering signals; performing one or more feature extraction techniques to the preliminary identification; applying a pattern classification to features of the one or more interfering signals extracted using the one or more feature extraction techniques to yield one or more classified patterns; and applying a trained machine learning model to the one or more classified patterns to classify the one or more interfering signals.

In another aspect, the method further includes providing as an additional input into the trained machine learning model, one or more of the signal or cross layer sensing statistics associated with the signal.

In another aspect, at least one of the one or more interfering signals is classified as a new type of interfering signal not previously known to the trained machine learning model.

In another aspect, the method further includes updating the trained machine learning model to learn the new type of interfering signal for future classification.

In another aspect, the corresponding type for each of the one or more interfering signals includes one of meaconing, spoofing, jamming, or chirp signal.

In another aspect, the interference mitigation scheme is one of adaptive beamforming, multi-tone cancelation, and adaptive filter-based interference excision.

In another aspect, the intended signal is a Global Positioning System (GPS) signal.

In one aspect, a radio receive includes one or more antennas configured to receive a signal, wherein the signal includes an intended signal sent for reception by the radio receiver and one or more interfering signals. The radio receiver further includes one or more memories configured to store computer-readable instructions; and one or more processors. The one or more processors are configured to execute the computer-readable instructions to apply, in real-time, a first signal processing procedure to the signal to classify a corresponding type for each of the one or more interfering signals; determine an interference mitigation scheme for each type of interfering signal; apply, in real-time, a second signal processing procedure to the signal to mitigate the one or more interfering signals using the interference mitigation scheme for each type of interfering signal; and output the intended signal.

In another aspect, the first signal processing procedure and the second signal processing procedure are applied to the signal simultaneously.

In another aspect, the first signal processing procedure is applied to the signal first, prior to the second signal processing procedure being applied.

In another aspect, the first signal processing procedure includes performing a preliminary identification of the one or more interfering signals; performing one or more feature extraction techniques to the preliminary identification; applying a pattern classification to features of the one or more interfering signals extracted using the one or more feature extraction techniques to yield one or more classified patterns; and applying a trained machine learning model to the one or more classified patterns to classify the one or more interfering signals.

In another aspect, the one or more processors are further configured to provide as an additional input into the trained machine learning model, one or more of the signal or cross layer sensing statistics associated with the signal.

In another aspect, the corresponding type for each of the one or more interfering signals includes one of meaconing, spoofing, jamming, or chirp signal, and the interference mitigation scheme is one of adaptive beamforming, multi-tone cancelation, and adaptive filter-based interference excision.

In another aspect, the radio receiver is installed in an object involved in a mission critical communication with one or more transmitters, and the one or more interfering signals include one or more of a radar signal, a Global Positioning System (GPS) signal, a cellular technology-based signal, and a WiFi signal.

In one aspect, One or more non-transitory computer-readable media includes computer-readable instructions, which when executed by one or more processors of a radio receiver, cause the radio receiver to receive a signal, wherein the signal includes an intended signal sent for reception by the radio receiver and one or more interfering signals; apply, in real-time, a first signal processing procedure to the signal to classify a corresponding type for each of the one or more interfering signals; determine an interference mitigation scheme for each type of interfering signal; apply, in real-time, a second signal processing procedure to the signal to mitigate the one or more interfering signals using the interference mitigation scheme for each type of interfering signal; and output the intended signal.

In another aspect, the first signal processing procedure includes performing a preliminary identification of the one or more interfering signals; performing one or more feature extraction techniques to the preliminary identification; applying a pattern classification to features of the one or more interfering signals extracted using the one or more feature extraction techniques to yield one or more classified patterns; and applying a trained machine learning model to the one or more classified patterns to classify the one or more interfering signals, wherein in addition to the one or more classified patterns, one or more of the signal or cross layer sensing statistics associated with the signal are provided as additional inputs to the trained machine learning model.

In another aspect, the corresponding type for each of the one or more interfering signals includes one of meaconing, spoofing, jamming, or chirp signal, and the interference mitigation scheme is one of adaptive beamforming, multi-tone cancelation, and adaptive filter-based interference excision.

### BRIEF DESCRIPTION OF SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a non-limiting example of an environment in which signal detection and characterization techniques of the present disclosure may be applied, according to some aspects of the present disclosure.

FIG. 2 illustrates an example antenna system for performing signal detection and classification, according to some aspects of the present disclosure.

FIG. 3 illustrates an example architecture of signal detection and classification techniques, according to some aspects of the present disclosure.

FIG. 4A illustrates an example signal processing for coarse signal classification according to some aspects of the present disclosure.

FIG. 4B illustrates an example signal processing for coarse signal classification, according to some aspects of the present disclosure.

FIG. 5 illustrates an example of a time-frequency map for identifying a signal of interest according to some aspects of the present disclosure.

FIG. 6 is a flowchart of an example signal detection and classification and interference mitigation technique, according to some aspects of the present disclosure.

FIG. 7 is a flowchart of an example signal detection and classification and interference mitigation technique, according to some aspects of the present disclosure.

FIG. 8 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

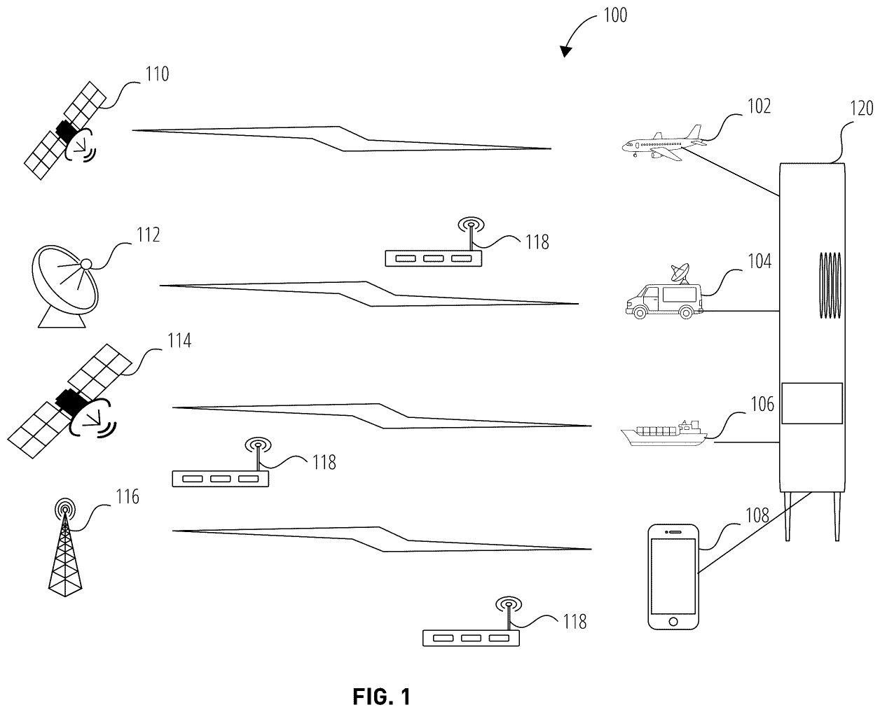

FIG. 1 illustrates a non-limiting example of an environment in which signal detection and characterization techniques of the present disclosure may be applied, according to some aspects of the present disclosure.

Example environment 100 illustrates a multi-platform setting in which various systems operating based on same or different communication technologies (e.g., radar, cellular, and/or WiFi technologies) to send and transmit signals over same and/or overlapping frequency channels. In this example, environment 100 may include objects 102, 104, 106, and 108.

For example, object 102 may be an aircraft communicating with satellite 110. In another example, object 102 may communicate with a ground-based transmitter (not shown) either directly or via satellite 110. In another example, object 104 may communicate with another airborne vehicle (e.g., a drone, another aircraft, etc.).

Object 106 may be a ground-based vehicle with communication capabilities to operate using radar and/or cellular-based (e.g., 5G, 6G, etc.) technologies. For example, object 106 may be a portable TV broadcasting unit with radar and/or cellular-based receivers configured to communicate with transmitter/receiver 112. In another example, object 106 may communicate with a satellite, a nearby cellular base station, etc.

Object 106 may be a maritime vehicle that may communicate with satellite 114. In another example, object 106 may communicate with a ground transmitter/receiver similar to transmitter/receiver 112.

Object 108 may be an end-user equipment (user equipment (UE)). Non-limiting examples of UEs include any known or to be developed handheld devices such as mobile phones, laptops, tablets, wireless controllers (e.g., for drones), Internet of Things (IoT) devices, etc., capable of establishing wireless communication with other devices using radar, cellular, and/or WiFi technologies (e.g., any known or to be developed WiFi technology). For example, object 108 may communicate with base station 116.

While in FIG. 1, each one of object 102, object 104, object 106, and object 108 is shown to have a dedicated communication with a separate receiving/transmitting component (i.e., one of satellite 110, transmitter/receiver 112, satellite 114, and base station 116), the present disclosure is not limited thereto. In one example, each one of object 102, object 104, object 106, and object 108 may communicate with more than one of receiving/transmitting component. Furthermore, two or more of object 102, object 104, object 106, and object 108 may communicate with the same receiving/transmitting component.

Environment 100 may further include one or more transmitting elements 118. These transmitters may include any radio equipment capable of generating and transmitting wireless signals over same and/or overlapping frequency channel(s) as those over which object 102, object 104, object 106, and/or object 108 operate. For example, transmitting elements 118 may operate to generate and transmit unintended/interfering signals for purposes such as, but not limited to, jamming a receiver at any one or more of object 102, object 104, object 106, object 108, etc.

The number of and/or the type of objects in environment 100, are for illustrative purposes only. Environment 100 may include any other type of known or to be developed object with an RF receiver/transmitter and/or may include more or less than objects shown in FIG. 1.

In environment 100, signals are transmitted and received across ground, airborne, space-based, vehicle-based, and maritime domains. Navigation systems (e.g., GNSS, radar navigation, maritime positioning systems) rely on RF signals vulnerable to interference. The proposed antenna system, deployed across receivers in these domains, enables real-time classification of interference signals. By identifying interference types, the system allows for adaptive mitigation strategies before navigation reliability is compromised. Proposed antenna system of the present disclosure (that may be deployed in each of object 102, 104, 106, and 108) performs real-time classification of received signals, determining whether the interference is jamming, spoofing, or unintentional (e.g., overlapping radar or WiFi). The results are communicated to processor 120, which applies targeted mitigation such as adaptive filtering, null steering, or signal substitution. While, for simple illustration, FIG. 1 shows a single processor 120 communicatively coupled to object 102, object 104, object 106, and object 108, the present disclosure is not limited thereto. In one example, a separate processor 120 may be embedded within each receiver at each of object 102, object 104, object 106, and object 108. Processor 120 may be remotely located relative to object 102, object 104, object 106, and/or object 108 and communicatively coupled to receivers thereof. Operations of processor 120 and/or outputs thereof (e.g., signal classification results) may be accessible via a terminal connected thereto (e.g., a terminal operated by a respective operator controlling operations of object 102, object 104, object 106, and/or object 108).

In one example, a processor such as processor 120 and a receiver/transmitter component of each one of object 102, object 104, object 106, and object 108 may form an antenna system that is used for signal detection and classification techniques described herein.

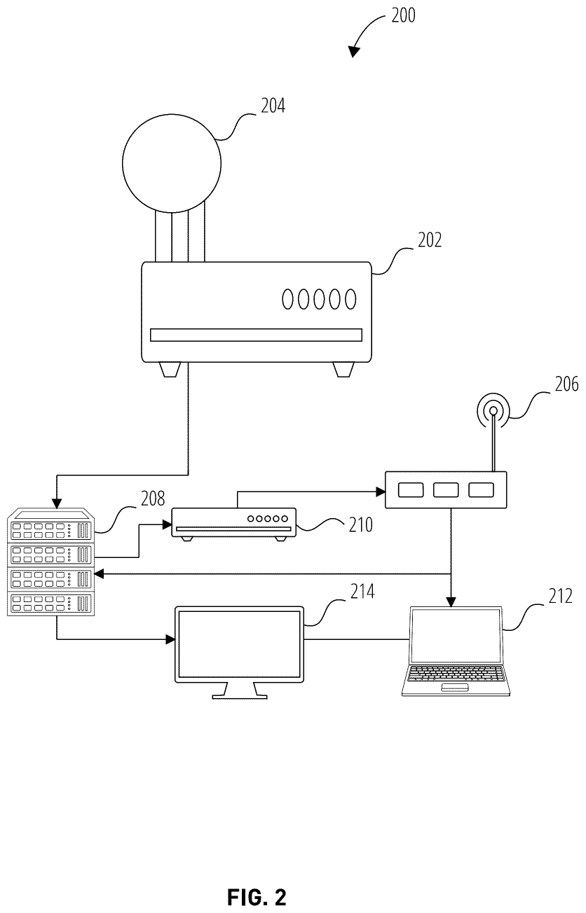

FIG. 2 illustrates an example antenna system for performing signal detection and classification, according to some aspects of the present disclosure.

Antenna system 200 of FIG. 2 may include a software defined radio (radio 202). A non-limiting example of radio 202 is a USRP X310 (e.g., with TwinRX Daughter boards). However, the present disclosure is not limited to USRP X310 as a software defined radio and instead any other known or to be developed software defined radio may be used instead.

Radio 202 may include, among other components, a receiver antenna 204. Receiver antenna 204 may be a Global Navigation Satellite System (GNSS) receiver antenna. A non-limiting example of receiver antenna 204 is an Anctom 4-element Controlled Reception Pattern Antenna (CRPA) with a Low Noise Amplifier (LNA) (4) connection. However, any other known or to be developed suitable receiver antenna may be used instead. Radio 202 may further include a transmitter (not shown).

Antenna system 200 may further include receiver 206. A non-limiting example of receiver 206 is a GNSS receiver NovAtel PwrPak7D. However, any other known or to be developed suitable receiver may be used instead. In one example, receiver 206 may be embedded within radio 202.

Antenna system 200 may further include a compute engine 208 (a processor). Compute engine 208 may be any suitable computing system including, but not limited to, a personal computer with one or more Graphic Processing Units (GPUs). Compute engine 208 can be a personal computer or can be a cloud-based server on a public, private, or a hybrid cloud service. Compute engine 208 may execute computer-readable instructions to implement signal detection and classification techniques of the present disclosure. Compute engine 208 may be communicatively coupled to radio 202. Compute engine 208 can also be implemented as a Field-Programmable Gate Array (FPGA), an Application-Specific Integrated Circuit (ASIC), etc.

Antenna system 200 may further include a receiver/transmitter, which can be a software defined radio (radio 210)). A non-limiting example of radio 210 is a USRP B210. However, any other known or to be developed suitable radio may be used instead. Radio 210 may be in communication with receiver 206 and compute engine 208.

Antenna system 200 may further include signal monitoring device 212. A non-limiting example of signal monitoring device 212 is a GPS signal monitoring device. Signal monitoring device 212 may be communicatively coupled to receiver 206, as shown in FIG. 2. As will be described below, in one non-limiting example, an intended signal may be a GPS signal, which may have been subject to various types of interference. After signal detection, classification, and interference mitigation according to techniques of the present disclosure are applied, the intended GPS signal may be received on signal monitoring device 212. More generally, any type of intended signal (which may not necessarily be GPS) or information related to the intended signal such as cross-layer statistics or other parameters pertaining to the intended signal, may be received and displayed on signal monitoring device 212.

Antenna system 200 may further include terminal 214. Terminal 214 may be communicatively coupled to signal monitoring device 212 and/or compute engine 208. Via terminal 214, operations of antenna system 200 may be controlled, classified interfering and intended signals identified for an operator (e.g., to interact with, modify, tag, etc., for future classification training purposes).

In one example, signal monitoring device 212 and terminal 214 may be combined into a single device (e.g., a laptop, a tablet, a mobile device, etc.).

While antenna system 200 is shown as having several different physical components, the present disclosure is not limited thereto. Antenna system 200 may have any known or to be developed form factor and may be packaged differently (e.g., one or more components may be combined) for an intended application or device to be used in.

In one non-limiting example, operation of antenna system 200 may include radio 202 receiving, via receiver antenna 204 a signal (e.g., a signal that includes an intended signal such as a GPS signal and one or more interfering signals). The signal may be sent to compute engine 208. Signal detection, classification, and interference mitigation techniques described herein, may be applied to the signal at compute engine 208. The resulting signal (interference suppressed signal) may then be transmitted to radio 210. Radio 210 may then transmit the resulting signal to receiver 206, which in turn provides the signal to signal monitoring device 212.

Signal detection and classification techniques that will be described hereinafter, may be referred to as Signal Classification using Novel RF machine learning of Positioning, Navigation and Timing (PNT) Interference in Contested spectrum Environments (SCORPION).

Currently, navigation systems depend on RF signals that can be influenced by a variety of interference sources. For instance, in mission critical settings, intended recipients of communication signals (e.g., airplanes, maritime vessels, drones, mobile telephones, pagers, etc.) are likely to face complex, contested, and congested RF spectrum environment against increasingly sophisticated interferers (e.g., adversaries, rogue players and transmitters, etc.). One non-limiting example of such challenge may be within Anti Access Area Denial (A2AD) construct. In these instances, it is a challenge to understand the signal characteristics quickly enough to react to/mitigate negative impacts. Current antenna technologies treat all signals the same and attempt to ignore them equally. With more sophisticated interference sources, current antenna technologies are inadequate and inefficient. SCORPION aims to address the shortcomings of current antenna technologies used for signal detection and classification in congested RF environments.

SCORPION provides a generic and extensible antenna system architecture that includes a complete hardware and software solution, such as the non-limiting example antenna system 200 of FIG. 2. This solution provides a robust and resilient PNT operation by using state-of-the-art statistical signal processing and AI/ML assisted interference/spoofer detection and characterization. SCORPION provides highly effective interference detection and characterization tool that helps receivers to tactically choose the best configuration to minimize and mitigate various types of interferences.

As noted SCORPION may be implemented using a hardware and software solution. Hardware component of the solution may be provided via antenna system 200 (may be referred to as RF Front-end (RFFE). Software component of the solution may include Blind Source Separation and Interference/Spoofer Detection and Characterization (IDC), Interference Mitigation Techniques Selection (IMTS), and Interference Mitigation (IM), each of which will be described below.

SCORPION uses a hybrid and adaptive approach that may be formed of the best of both statistical signal processing and machine learning to detect and characterize interference/spoofing. In one example, IDC Module provides its decisions to the IMTS Module, which in turn orchestrates interference mitigation techniques (e.g., Adaptive Beamforming, Multi-tone Cancellation, Adaptive Filter-based Interference Excision etc.). The IDC Module is driven by blind signal separation and direction finding, cross layer sensing (examples of cross layer sensing techniques are described in U.S. application Ser. No. 17/933,452 filed by A10 Systems, Inc., on Sep. 19, 2022 (and issued as U.S. Pat. No. 12,316,547 on May 27, 2025), the entire content of which is incorporated herein by reference), image processing, statistical signal processing, pattern classification, and interference specific detectors. All these feature extractors feed into the Multimodal Fusion Module, which makes the decision on whether interference is present, and what type of interference is present. Within the IDC Module, Multi-Modal Fusion block performs open set classification and open world discovery using another feedback loop. If the Multimodal Fusion determines that an interferer is of New and Unknown type it calls the Open World Discovery Module which either creates a new class based on the unknown/never seen before type of interferer and/or performs model updates so that next time the same interferer is seen, the interference is part of the model and is detected rapidly.

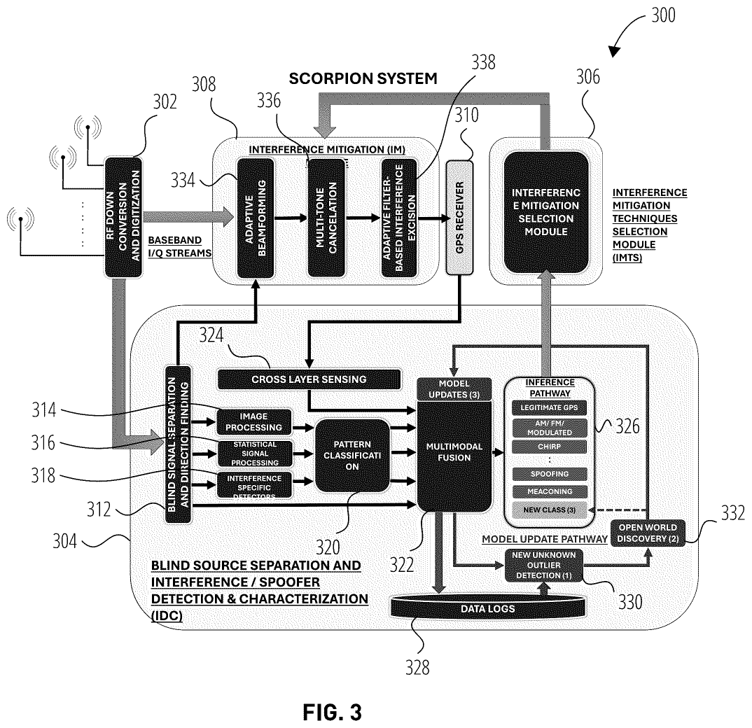

FIG. 3 illustrates an example architecture of signal detection and classification techniques, according to some aspects of the present disclosure.

Example architecture 300 shows various logical elements of the software component of SCORPION as described above. The logical elements shown as part of architecture 300 may be implemented on compute engine 208 of antenna system 200 of FIG. 2.

Initially, a received signal may be down converted and/or digitized using any known or to be developed signal processing technique. This conversion and digitization process may be carried out using logic 302. Logic 302 may be implemented on radio 202 or alternatively on compute engine 208. As noted above, a received signal is assumed to include an intended signal (e.g., a GPS signal, a radar signal, a satellite signal, a cellular such as 4G/5G/6G signal, a WiFi signal, etc.) and one or more interfering signals. Interfering signals may be transmitted according to any known or to be developed schemes including, but not limited to, Meaconing, jamming, spoofing, a chirp signal, etc. Interfering signals may be transmitted via other objects (e.g., object 104, object 106, and/or object 108, assuming object 102 is the intended object performing signal detection, classification and interference mitigation according to the present disclosure), via transmitters 118, etc.

As can be seen, the received signal may include a baseband, as well as In-phase and Quadrature components (I/Q). I/Q components, after being down-converted and digitized using logic 302, may be fed into two different logics and subject to different signal processing routines as will be described. One component is a Blind Source Separation and Interference/Spoofer Detection and Characterization Module (IDC) logic (IDC 304). As will be described in more detail below, signal processing and analysis performed on the received signal by IDC 304 results an initial identification of interfering signals, followed by a series of signal processing steps that extract/identify various features embedded in these initially identified interfering signals. The extracted features, along with one or more additional data, may be fed into a trained AI model, the output of which would result in a more precise identification of each interfering signal (e.g., Meaconing, Spoofing, Chirp, and in some instances identification and labeling of never-seen-before interference types, etc.). The identified interference signal(s) are then fed into an Interference Mitigation Techniques Selection (IMTS) module (IMTS 306). In one example, IMTS 306 determines (selects) a corresponding interfering mitigation technique for each type of interfering signal to be used for mitigating the effects of the interfering signal on the underlying intended signal (which in one example can be a GPS signal).

The other logic to which the down-converted and digitized signal is fed, is an Interference Mitigation (IM) logic (IM 308). As will be described in more detail below, IM 308 receives as input the signal as well as an interference mitigation technique determined and provided by IMTS 306. Using the mitigation technique, IM 308 subjects the signal to a number of different processes (e.g., one or more of beamforming, multi-tone cancellation, adaptive filter-based interference excision, etc.) in order to identify the intended signal, which in example of FIG. 3 is a GPS signal received by GPS receiver 310 (and may then be provided to signal monitoring device 212 of FIG. 2).

In one example, between 308 (IM) and 310 (GPS receiver), there may be a transmitter (e.g., similar to 210, a software defined radio) to convert the digital signal out of 308 to RF signal before sending it to the 310 (GPS receiver), unless the GPS receiver is implemented in the baseband.

The GPS signal may further be subject to unique Cross Layer Sensing (CLS), examples of which are described in U.S. application Ser. No. 17/933,452 filed by A10 Systems, Inc., on Sep. 19, 2022 (and issued as U.S. Pat. No. 12,316,547 on May 27, 2025), the entire content of which is incorporated herein by reference. The output of CLS is another input in the trained AI model of IDC 304.

In summary, SCORPION system 300 provides the necessary logic and processing capabilities to subject a received signal, that comprises one or more intended signals affected by one or more sources of interference, to two different processes that may be carried on in parallel. One process (carried by IDC 304) is for identification and labeling of the different types of interference signals affecting the one or more intended signal. The output of IDC 304 feeds into determining a proper interference mitigation technique to be applied to the signal (by IM 308) in order to mitigate the effects of the interfering signal(s) on the intended underlying signal(s).

In one example, the two processes by IDC 304 and IM 308 may be carried out simultaneously and in real-time. In another example, one process may lag the other by a period of time (e.g., a few milliseconds, a second, etc.). The period of time of the lag may be determined based on experiments and/or empirical studies. For instance, the processing by IM 308 may be delayed by such period of time relative to the processing by IDC 304 in order for the interference mitigation technique to be identified and subsequently applied to the signal by IM 308.

As noted on several occasions above, example SCORPION system 300 enables an on-demand, real-time, and accurate identification of complex and sometime never-seen-before sources of interference on an intended signal, along with effective techniques for suppressing the effects of such interference on the intended signal.

Hereinafter, details of IDC 304 and IM 308 will be described.

IDC 304, upon receiving the signal (down-converted and digitized), may subject the signal to a blind signal separation and direction finding process in order to identify the interference sources. Direction finding is a useful feature in that in scenarios where the interference source is another signal that is the same as the intended signal (e.g., another GPS signal), direction finding can be used to identify the angle of and direction from which the spoofing GPS signal is received. As noted above, this blind signal separation and direction finding functions as a preliminary filter. This preliminary filter may often identify characteristics of interfering signals that may be shared by different types of interference, hence making this process preliminary/blind. In one example, this blind signal separation and direction finding process may be carried out by logic 312.

In one example, logic 312 may be applied to the signal as follows. A spatial filter bank of blind signal copy algorithms tuned to the interferers of interest may be utilized. The output of these algorithms can include beamforming weights and Signal-to-Interference-plus-Noise Ratio (SINR) estimates for each signal type, as well as intermediate statistics such as cross correlation statistics. This algorithms separate overlapped co-channel interferers prior to more sophisticated machine learning classifiers. This is advantageous because SCORPION system 300 operates based on the assumption of no knowledge/information of the signal being transmitted by non-cooperative transmitters or jammers. Using such techniques, logic 312 is able to identify signals from the non-cooperative transmitters and enhance the same using universal and simple properties inherent in any structured signal. The standard GPS waveform, for example, is bounded and belongs to a low order QAM constellation, whose properties can be exploited.

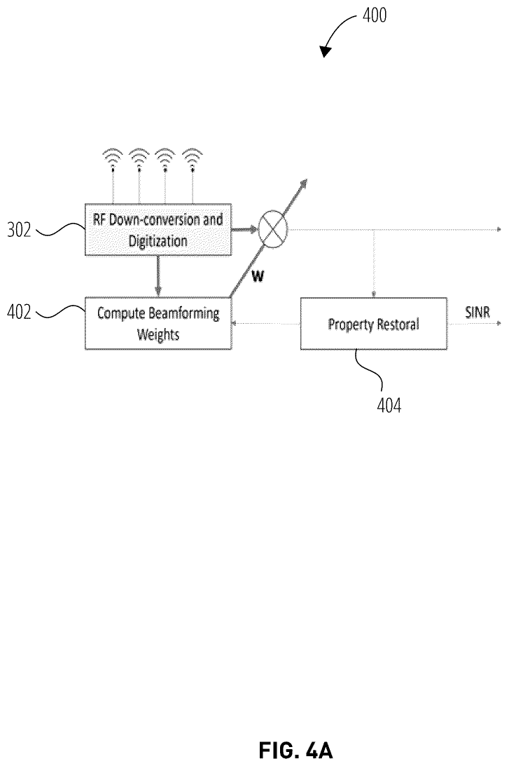

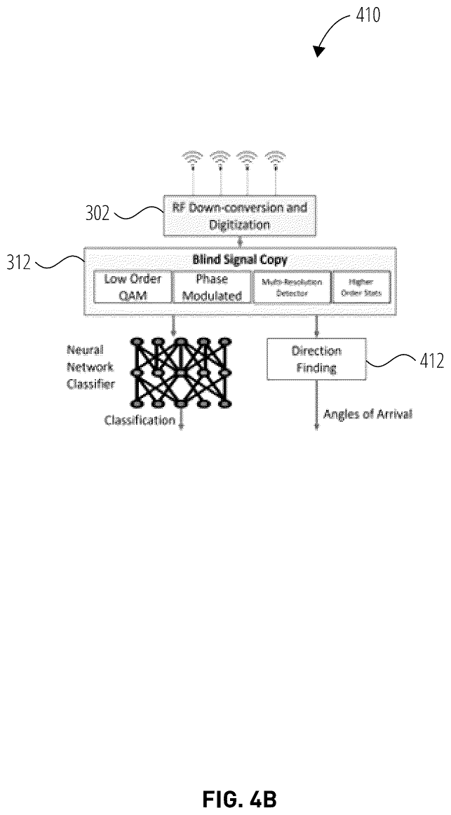

At a coarse level the signal processing by logic 312 takes the form shown in FIG. 4A and FIG. 4B.

FIG. 4A illustrates an example signal processing for coarse signal classification according to some aspects of the present disclosure.

Process 400 of FIG. 4A shows that a signal, upon being down-converted and digitized using logic 302, is processed by logic 312 in order to determine beamforming weights (e.g., using compute beamforming weights logic 402) and SINR using property restoral logic 404. In one example, a standard least squares beamforming is formed after cross correlating against an estimated signal \hat{d}(n). The estimated signal can be an output of a nonlinear property restoral step using logic 404. An example nonlinear property restoral would-be forcing unity modulus for a constant modulus signal. The technique can be extended to capture multiple overlapped signals of interest (SOIs), even if they have the same property, by assuming that the SOIs are weakly uncorrelated.

FIG. 4B illustrates an example signal processing for coarse signal classification, according to some aspects of the present disclosure.

In a variant of process 400, process 410 of FIG. 4B illustrates that a down-converted and digitized signal (e.g., using logic 302), may be subject to a number of different processes (bling signal copy processing) by logic 312 including, but not limited to, low order QAM, phase modulation, multi-restoration detection, and higher order statistical analyses. The parameters extracted from these properties can then be used to determine the direction of the interfering signal using logic 412 (determine Angle of Arrival (AoA) and may then be fed into a trained AI model for more accurate signal classification as will be described below.

In one example, a multi-resolution front end, such as a wavelet transform, may be applied to the signal as part of the blind signal copy processing by logic 312. This may be advantageous because wavelet shrinkage can be used to perform a Dominant Mode Prediction (DMP) estimator of beamformer weights for signals whose support lies in known regions of the time-frequency map. Also, the adaptive beamforming and the classification of jammers can be performed at lower sample rates than the GPS signals themselves, because the sufficient statistics are all second order correlation statistics. Once structured signals are removed, any signal that remain can be further processed in a lower interference environment.

In one example, bling signal copy processing may include simulation of a 4-element array that receives three signals (e.g., a BPSK waveform (an SOI) at a 25-degrees AOA and at a 25 dB Signal to White Noise Ratio (SWNR), a Chirp received at a 150-degrees AOA at 25 dB SWNR and a tone received at −15 degrees and a 30 dB SWNR). In this example, the BPSK waveform as the SOI, may be the weakest signal in the environment. The blind signal copy processing can restore the signal to its nearest constellation point to capture and copy the BPSK signal at a 30 dB SWNR, cancelling the interfering jammers. In one example, prior to beamforming, a wavelet decomposition may be performed to create a time-frequency map of the environment of the signal, using the Morlet wavelet.

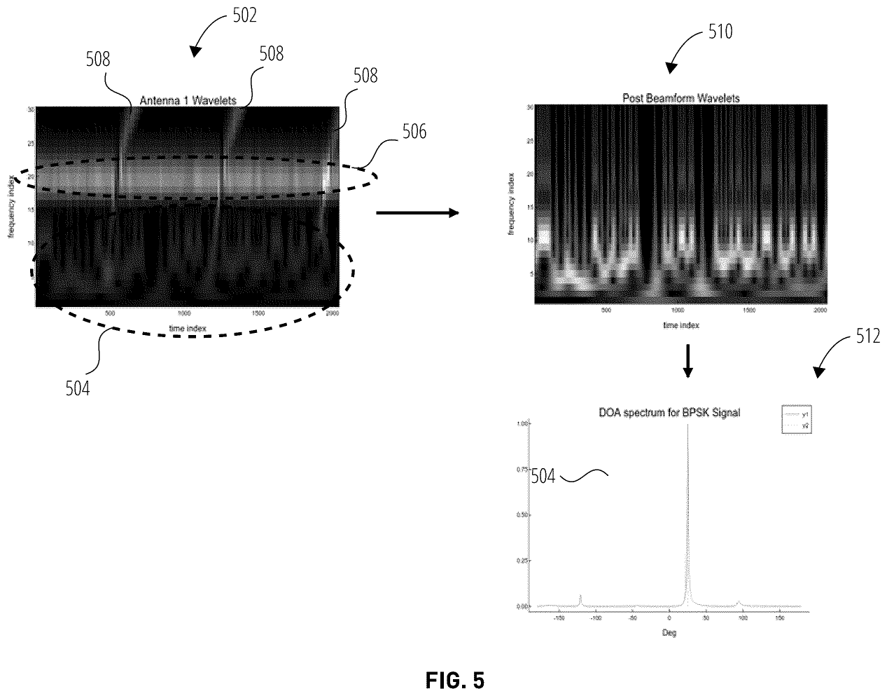

FIG. 5 illustrates an example of a time-frequency map for identifying a signal of interest according to some aspects of the present disclosure. From this set of beamforming weights, logic 312 can determine a Direction Finding (DF) spectrum that has a peak at the correct Direction of Arrival (DOA). As shown in example spectrum 502, the BPSK waveform 504 is at the lower frequency indices, while tone signal 506 (e.g., an interfering signal) occupies the frequency index near 18, and the chirp waveform 508 (e.g., interfering signal) are the rising slopes that appear periodically throughout the heatmap. After copying BPSK signal, at the output of the beamformer, wavelet heatmap 510 may be obtained. From this set of beamforming weights, a DF spectrum 512 that has a peak at the correct DOA may be obtained. DF spectrum 510 shows the SOI (signal 504).

Referring back to FIG. 3, output of logic 312 may be one or more preliminarily identified interfering signals. Each identified interfering signal may then be subject to a number of different feature extraction processes including, but not limited to, image processing by image processing logic 314, statistical signal processing by statistic signal processing logic 316, and/or interference specific detection by detector logic 318.

In one example, image processing logic 314 operates on the 2-D waterfall plots that consists of Power Spectral Density (PSD) estimates across frequency along one axis and time along the other (Waterfall/Spectrogram). Image processing logic 314 can perform clustering (e.g., K-means clustering) of energies to detect and characterize bursty and Frequency-Hopping Spread Spectrum (FHSS) signals. In one example, since clustering by itself is expensive and consumers a significant amount of resources, one or more machine learning/AI models may be trained to use K-means clustering to detect and characterize FHSS and bursty signals. Image processing is a very good technique to obtain broadband spectrum situational awareness.

Image processing by logic 314 to extract signal features (e.g., features of FHSS and bursty signals) is not limited clustering and/or AI-based clustering methods. Any other known or to be developed image processing technique that can identify features of interfering signals may be utilized instead.

Furthermore, any known or to be developed statistical processing techniques and/or interference specific detection may be utilized by logic 316 and logic 318 respectively, in order to extract signal features. For example, features extracted by logics 314, 316, and 318 may include, but are not limited to, meaningful signal features such as spectral features (e.g., bandwidth, center frequency, spectral shape), temporal features (e.g., pulsed vs. continuous, bursty vs. steady), statistical features (e.g., variance, kurtosis, cyclostationary properties), performance metrics (e.g., SINR, correlation loss, lock stability), etc.

Once all signal features are extracted using logic 314, logic 316, and logic 318, the extracted features may then be fed into pattern classification logic 320. In one example, pattern classification logic 320 may utilize any known or to be developed techniques (e.g., thresholding, clustering, etc.) to identify/classify patterns in the interfering signals.

In one example, outputs of classification logic 320 may then be fed into a trained AI model. This trained AI model is shown as multimodal fusion logic 322 in FIG. 3. Such AI model may be trained using any known or to be developed techniques. The AI model training may be supervised or semi-supervised (e.g., using random forest training technique).

In one example, operations of multimodal fusion logic 322 may be premised on (i) dataset generation and preprocessing of data for extracting features of interest, (ii) multimodal fusion, (iii) outlier/out of distribution detection and (iv) continual learning.

In one example, dataset generation and preprocessing of data for extracting features of interest may be as follows. CSP algorithms can be used to extract highly discriminative features from most RF signals based on periodically time-variant probabilistic parameters and their estimates for the signal. Since the full pipeline of CSP requires significant processing power to generate features, longer signal collection times, and expert knowledge, the multimodal fusion logic 322 is trained on intermediate features extracted through logic 314 for image processing (e.g., creating time-frequency spectrograms), logic 316 for statistical signal processing, logic 318 for interference-specific features, as well as raw IQ samples from the antennas may also be used in training the AI model. Alongside I/Q data, Cross Layer Statistics (e.g., GPS SNR/CNR, etc.), CSP, Direction of Arrival and Images of Waterfalls extracted from the signal as part of the blind signal separation, additional interference-related features such as Signal Rise Time, Chirp Rate, Detection of Tones etc., may also be used in training multimodal fusion logic 322.

Multimodal fusion may operate as follows. Different modalities capture the situational state of the environment from different perspectives. For example, the AI model may be designed as IQ-based convolutional neural networks (CNNs) and Transformer models with the objective to learn latent, lower dimensional representations of sources that are jointly informative. Base network architectures designed and optimized for each modality will be combined and fused in ways that reinforce orthogonality/diversity across latent representations per modality. Through re-training with novel training functions that enforce information-theoretic diversity across latent representations, each modality will contribute to downstream tasks (like interferer type detection) in a complementary fashion, adding/augmenting information extracted from other modalities (rather than producing latent features that are highly correlated, or providing correlated information, across modalities).

The AI model of multimodal fusion logic 322 is trained on and operates based on a combination of features described above. This constitutes a multimodal fusion approach as the inputs are composed of 2-D spectrograms (images) and 1-D vectors (I/Q samples, CSP features etc.). The benefit of using I/Q samples is clear. For example, only 256 I/Q samples are sufficient to detect an underlay Direct Sequence Spread Spectrum (DSSS) signals embedded within LTE signals. To exploit the complementary information within the I/Q data and spectrogram images, one of late aggregate fusion or joint fusion approach may be utilized. Late aggregated fusion includes aggregation of separate predictions through weighted combination of the final decision outcomes. Joint fusion includes fusion of the extracted features from I/Q samples, CSP features, waterfalls, etc., to generate a joint prediction.

Outlier/out of distribution (OOD) detection may operate as follows. OOD detection can be advantageous in interference classification, particularly in scenarios such as emergence of new types of intentional signal degrading transmitters, unlicensed users operating custom waveforms, various types of GPS spoofers, etc. Most existing OOD or novelty detection methods can be categorized as either kernel density-based, nearest neighbor-based, or reconstruction-based. In kernel density-based methods, the probability density function is estimated using large numbers of kernels distributed over the data space. Modeling the probability distribution over the data has achieved success on small-scale datasets, however, for high-dimensional and large datasets (e.g., occurring in environments such as environment 100 of FIG. 1), it is both computationally expensive and prone to overfitting. Nearest neighbor-based methods rely on the assumption that normal data points have close neighbors in the seen classes, while novel points are located far from those points. The definition of distance metric is important for these methods, but it is not well defined for radio signals that carry different contents or are of various lengths. Reconstruction-based methods, which rely heavily on neural networks, construct an encoding-decoding pipeline, and compute a novelty score through reconstruction error. One drawback of these methods is that they need to train a separate reconstruction neural network besides the classification pipeline. Moreover, previous works propose various methods to address novelty detection with benchmark image or text datasets only.

The present disclosure and multimodal fusion logic 322 provide a framework that given a dataset of signals from known protocols, the AI model is trained to correctly identify the protocol, if it occurs from one of previously encountered environmental conditions or protocol choices within the training dataset; otherwise, the classifier detects that a novel condition is encountered that suggests a new classification is needed. Using methodologies designed for RF fingerprinting, the ability of a transformer architecture can be exploited to operate on arbitrary positions of a sequence. To that end, a longer transmission burst composed of a stream of in-phase/quadrature (I/Q) samples may be broken down into smaller slices. Subsequently, each slice would be classified by the transformer separately. This allows multimodal fusion logic 322 to assess classifier confidence on a new transmission based on per-slice statistics: a broad array of tests can be designed, ranging from simple statistics of confidence of the classifier, such as the consistency of predictions, to measuring the Wasserstein/Earth Mover's Distance of the corresponding distribution the latent space of these slices, vis-à-vis data to ones observed in training data distributions.

Continual learning may operate as follows. New tasks could be given to SCORPION based on evolving sensing priorities or whenever new wireless standards are released. In such cases, naively re-training the model for the new tasks may cause the model to forget the older ones. An alternative solution is presented to combine the data from old and new tasks and train the model from scratch with combined classes. This solution comes at the expense of increased training cost. To address this issue, multimodal fusion logic 322 is designed for lifelong learning. Lifelong learning may be implemented by virtually partitioning the matrix of model parameters to learn different tasks. In the case of model training, the model weights can be partitioned using flexible masks and a certain portion (e.g., a 50% partition) will be used for initial model training. As new tasks appear, and the model needs to adapt, a new partition (e.g., a 10% partition) of the unused model parameters will be re-trained specifically to learn the new task, while the new task shares the weights of all the old tasks. Besides reducing training cost, this method allows for having a single model for different tasks instead of having individual models for each task, where model parameters occupy a larger memory space. This approach can advantageously expand the ML model for successive sensing tasks under the constraints of model storage and processing capability but also identify thresholds when it is better to start off with a fresh ML model instead of expanding the original one.

With design, training and operation of multimodal fusion logic 322 described above based on (i) dataset generation and preprocessing of data for extracting features of interest, (ii) multimodal fusion, (iii) outlier/out of distribution detection and (iv) continual learning, examples of operation of multimodal fusion logic 322 in classifying interfering signals will be described next.

As noted above, outputs of classification logic 320 may be provided as input into multimodal fusion logic 322. In one example, in addition to output of classification logic 320, the original I/Q and baseband component of the signal as received by logic 312 may also be provided as input into multimodal fusion logic 322. In yet another example, outputs of CLS (e.g., performed by CLS logic 324 according to methods described in U.S. application Ser. No. 17/933,452 filed by A10 Systems, Inc., on Sep. 19, 2022 (and issued as U.S. Pat. No. 12,316,547 on May 27, 2025), the entire content of which is incorporated herein by reference), may also be provided as input in multimodal logic 322.

In some aspects and based on received inputs (e.g., classified patterns from classification logic 320, baseband and I/Q components of signal as received by logic 312, and/or CLS parameters from CLS logic 324), multimodal fusion logic 322 provides, as output, a concrete classification of each interfering signal. FIG. 3 illustrates output 326 that may be any one of several types of interference (e.g., Meaconing, spoofing, jamming, Chirp, AM/FM modulated, etc.). Output 326 may also indicate an interfering signal as a legitimate signal (e.g., legitimate GPS signal) that may not have been intentionally transmitted to cause interference on the intended signal. In one example, output of multimodal fusion logic 322 may indicate a new type of interference (not previously classified). In this instance, the signal may be classified in output 326 as “new class.”

As shown in FIG. 3, various data gathered from operation of multimodal fusion logic 322 (e.g., processing of inputs, resulting outputs, etc.) may be stored in data logs 328. Information in data logs 328 may be subsequently used for identifying a never-seen-before/“new class” interference signal.

As noted above, in some cases, output of multimodal fusion logic 322 may indicate that a particular interference signal is unknown/never-seen-before or simply an outlier that does not fit within any of the previously identified types of interference signals. In this instance, information stored in data logs 328 may be applied to the unknown/outlier signal using unknown/outlier detection logic 330. Output of logic 330 may then be subject to further processing using logic 332 (open world discovery), in an attempt to determine and classify this unknown interference as a “new class” interference while simultaneously feeding this new identification as feedback into updating the AI models of multimodal fusion logic 322 such that, in the future and in the event this “new class”interference is observed, the results can be indicated appropriately in output 326.

The classified interference signals at output 326 may then be fed into IMTS 306. IMTS 306 may identify a proper interference mitigation technique for each type of interference signal identified via output 326. Non-limiting examples of interference mitigation schemes include, but are not limited to, adaptive beamforming, multi-tone cancellation, adaptive filter-based interference excision, etc. Interference mitigation techniques are not limited to these examples and may encompass any other known or to be developed interference mitigation scheme.

Output of IMTS 306 (e.g., an interference mitigation scheme) may then be provided as input into IM 308. FIG. 3 shows three example logics as part of IM 308, each corresponding to a different interference mitigation technique (e.g., logic 334 for adaptive beamforming, logic 336 for multi-tone cancellation, and logic 338 for adaptive filter-based interference excision). Any one or more of these interference mitigation techniques may be applied to baseband and I/Q components (streams) of the signal received at antenna system 200 in order to mitigate the effects of the interference signal(s) and recover the intended underlying signal (e.g., a GPS signal), which is then provided to GPS receiver logic 310.

In one non-limiting example of adaptive beamforming being applied as interference mitigation technique, output of the blind signal separation and direction finding process by logic 312 may be provided as input into logic 334.

In one example, GPS receiver logic 310 may process the GPS signal and provide the same to signal monitoring device 212. As noted earlier, the intended GPS signal may then be subject to CLS via logic 324 in order for relevant parameters to be extracted and provided as input into multimodal fusion logic 322.

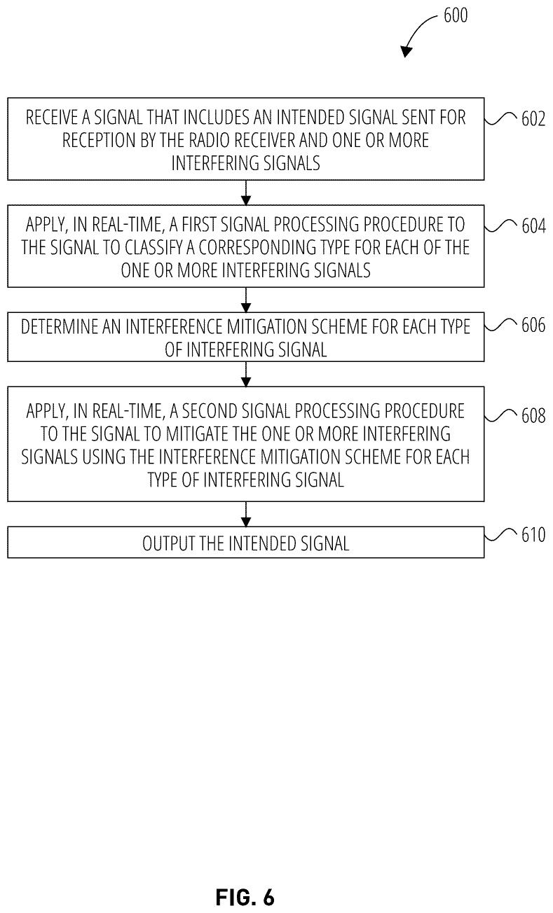

FIG. 6 is a flowchart of an example signal detection and classification and interference mitigation technique, according to some aspects of the present disclosure. Example steps of process 600 of FIG. 6 may be performed by any one or more components of antenna system 200 of FIG. 2 and by extension by appropriate logics of SCORPION system 300.

At step 602, antenna system 200 may receive one or more signals. In one example, as described above, wherein the signal includes an intended signal sent for reception by the radio receiver and one or more interfering signals. The signal may be received via receiver antenna 202. The signal may be subject to down conversion and digitization using logic 302 as described above with reference to FIG. 3.

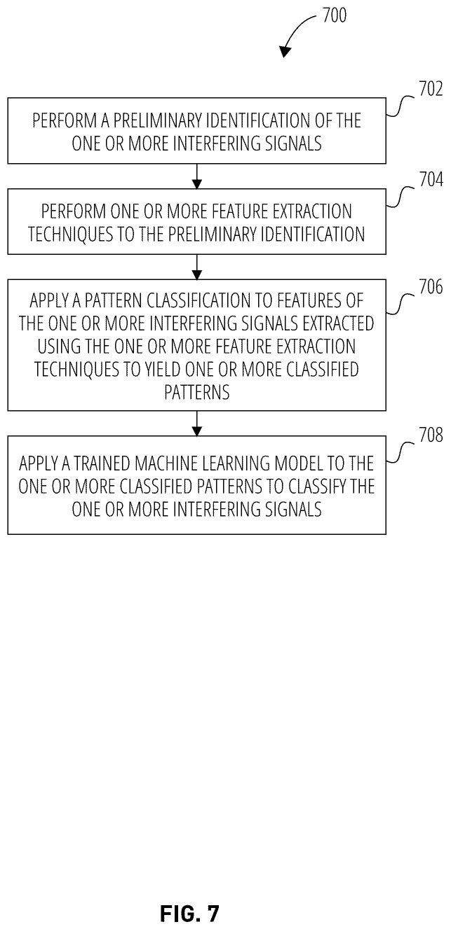

At step 604, antenna system 200 may apply, in real-time, a first signal processing procedure (e.g., interference signal identification and classification) to the signal to classify a corresponding type for each of the one or more interfering signals. This procedure may be applied using compute engine 208, which executes logics of SCORPION system 300 of FIG. 3. More specifically, this step may be performed via IDC 304 and various logics embedded therein as described above with reference to FIG. 3. Details of first signal processing procedure will be further described below with reference to FIG. 7.

In one example, the corresponding type for each of the one or more interfering signals includes one of meaconing, spoofing, jamming, or chirp signal.

At step 606, antenna system 200 may determine an interference mitigation scheme for each type of interfering signal classified at step 604. This step may be performed using compute engine 208, which executes logics of SCORPION system 300 of FIG. 3. More specifically, this step may be performed via IMTS 306 and various logics embedded therein as described above with reference to FIG. 3.

In one example, the interference mitigation scheme is one of adaptive beamforming, multi-tone cancelation, and adaptive filter-based interference excision.

At step 608, antenna system 200 may apply, in real-time, a second signal processing procedure (interference mitigation) to the signal to mitigate the one or more interfering signals using the interference mitigation scheme for each type of interfering signal. This step may be performed using compute engine 208, which executes logics of SCORPION system 300 of FIG. 3. More specifically, this step may be performed via IM 308 and various logics embedded therein as described above with reference to FIG. 3.

In one example, the first signal processing procedure and the second signal processing procedure are applied to the signal simultaneously. In another example, the first signal processing procedure is applied to the signal first, prior the second signal processing procedure is applied. In one example, the delay between application of first and second signal processing procedures may be determined based on experiments and/or empirical studies (e.g., a few milliseconds, a second, etc.).

At step 610, antenna system 200 may output the intended signal (e.g., a GPS signal) to signal monitoring device 212 as described above with reference to FIGS. 2 and 3.

FIG. 7 is a flowchart of an example signal detection and classification and interference mitigation technique, according to some aspects of the present disclosure. Example steps of process 700 of FIG. 7 may be performed by compute engine 208 of antenna system 200 of FIG. 2 and by extension by appropriate logics of SCORPION system 300, specifically IDC 304. Steps of process 700 correspond to machine learning based interference signal identification and classification (first signal processing procedure) described with reference to FIG. 3.

At step 702, compute engine 208 may perform a preliminary identification of the one or more interfering signals. In one example, this process corresponds to blind signal separation and direction finding performed using logic 312 as described above with reference to FIG. 3.

At step 704, compute engine 208 may perform one or more feature extraction techniques to the preliminarily identified interfering signals. Each preliminarily identified interference signal (e.g., output of logic 312) may be subject to one or more feature extraction techniques (e.g., using one of logic 314, 316, and 318).

At step 706, compute engine 208 may apply a pattern classification to features of the one or more interfering signals extracted using the one or more feature extraction techniques to yield one or more classified patterns. In one example, this step may be applied using logic 320.

At step 708, compute engine 208 may apply a trained machine learning model to the one or more classified patterns to classify the one or more interfering signals. In one example, this step may be applied using multimodal fusion logic 324 as described above with reference to FIG. 3. In one example, in addition to the classified patterns, one or more of the signal or cross layer sensing statistics associated with the signal are also provided as input into the trained machine learning model (e.g., multimodal fusion logic 324).

In one example, as part of performing interference signal classification at step 708, compute engine 208 may classify an interference signal as a new type of interfering signal not previously known to the trained machine learning model. This identification may trigger retraining of the AI/machine learning model to learn the new type of interfering signal for future classification as described above with reference to FIG. 3.

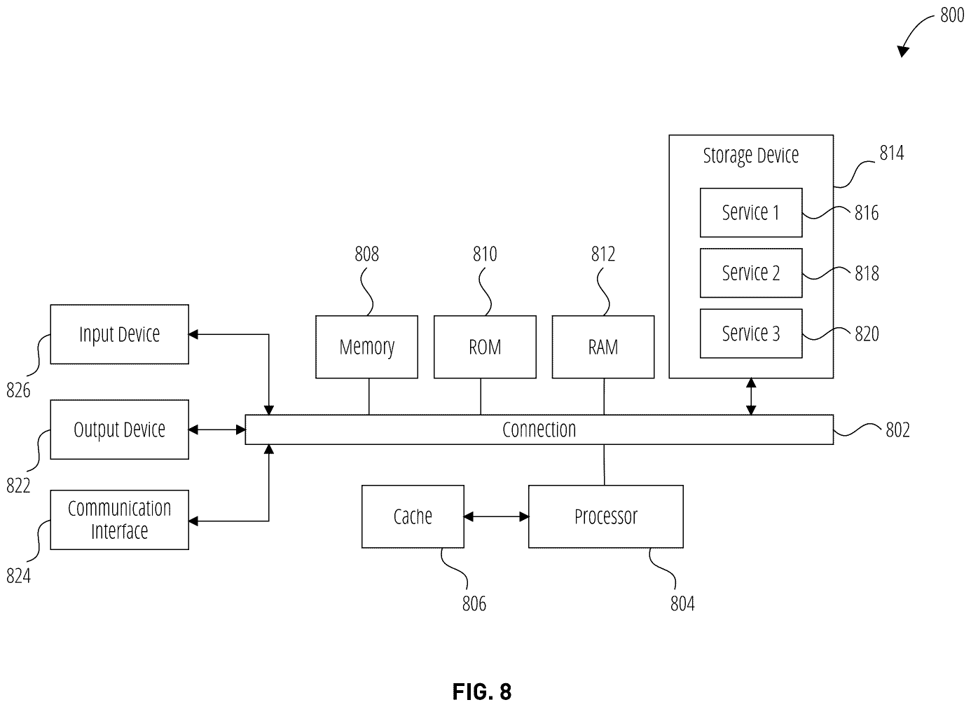

FIG. 8 shows an example of computing system 800, which can be for example any computing device making up any components of objects and elements in environment 100, antenna system 200, etc. Components of computing system 800 may be in communication with each other using connection 802. Connection 802 can be a physical connection via a bus, or a direct connection into processor 804, such as in a chipset architecture. Connection 802 can also be a virtual connection, networked connection, or logical connection.

In some examples, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804.

Processor 804 can include any general purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
receiving, at a radio receiver, a signal, wherein the signal includes an intended signal sent for reception by the radio receiver and one or more interfering signals;
applying, in real-time, a first signal processing procedure to the signal to classify a corresponding type for each of the one or more interfering signals;
determining an interference mitigation scheme for each type of interfering signal;
applying, in real-time, a second signal processing procedure to the signal to mitigate the one or more interfering signals using the interference mitigation scheme for each type of interfering signal; and
outputting the intended signal.

2. The method of claim 1, wherein the first signal processing procedure and the second signal processing procedure are applied to the signal simultaneously.

3. The method of claim 1, wherein the first signal processing procedure is applied to the signal first, prior to the second signal processing procedure being applied.

4. The method of claim 1, wherein first signal processing procedure comprises:
performing a preliminary identification of the one or more interfering signals;
performing one or more feature extraction techniques to the preliminary identification;
applying a pattern classification to features of the one or more interfering signals extracted using the one or more feature extraction techniques to yield one or more classified patterns; and
applying a trained machine learning model to the one or more classified patterns to classify the one or more interfering signals.

5. The method of claim 4, further comprising:
providing as an additional input into the trained machine learning model, one or more of the signal or cross layer sensing statistics associated with the signal.

6. The method of claim 4, wherein at least one of the one or more interfering signals is classified as a new type of interfering signal not previously known to the trained machine learning model.

7. The method of claim 6, further comprising:
updating the trained machine learning model to learn the new type of interfering signal for future classification.

8. The method of claim 1, wherein the corresponding type for each of the one or more interfering signals includes one of meaconing, spoofing, jamming, or chirp signal.

9. The method of claim 1, wherein the interference mitigation scheme is one of adaptive beamforming, multi-tone cancelation, and adaptive filter-based interference excision.

10. The method of claim 1, wherein the intended signal is a Global Positioning System (GPS) signal.

11. A radio receiver comprising:
one or more antennas configured to receive a signal, wherein the signal includes an intended signal sent for reception by the radio receiver and one or more interfering signals;
one or more memories configured to store computer-readable instructions; and
one or more processors configured to execute the computer-readable instructions to:
apply, in real-time, a first signal processing procedure to the signal to classify a corresponding type for each of the one or more interfering signals;
determine an interference mitigation scheme for each type of interfering signal;
apply, in real-time, a second signal processing procedure to the signal to mitigate the one or more interfering signals using the interference mitigation scheme for each type of interfering signal; and
output the intended signal.

12. The radio receiver of claim 11, wherein the first signal processing procedure and the second signal processing procedure are applied to the signal simultaneously.

13. The radio receiver of claim 11, wherein the first signal processing procedure is applied to the signal first, prior to the second signal processing procedure being applied.

14. The radio receiver of claim 11, wherein first signal processing procedure comprises:
performing a preliminary identification of the one or more interfering signals;
performing one or more feature extraction techniques to the preliminary identification;
applying a pattern classification to features of the one or more interfering signals extracted using the one or more feature extraction techniques to yield one or more classified patterns; and
applying a trained machine learning model to the one or more classified patterns to classify the one or more interfering signals.

15. The radio receiver of claim 14, wherein the one or more processors are further configured to provide, as an additional input into the trained machine learning model, one or more of the signal or cross layer sensing statistics associated with the signal.

16. The radio receiver of claim 11, wherein
the corresponding type for each of the one or more interfering signals includes one of meaconing, spoofing, jamming, or chirp signal, and
the interference mitigation scheme is one of adaptive beamforming, multi-tone cancelation, and adaptive filter-based interference excision.

17. The radio receiver of claim 11, wherein the radio receiver is installed in an object involved in a mission critical communication with one or more transmitters, and the one or more interfering signals include one or more of a radar signal, a Global Positioning System (GPS) signal, a cellular technology-based signal, and a WiFi signal.

18. One or more non-transitory computer-readable media comprising computer-readable instructions, which when executed by one or more processors of a radio receiver, cause the radio receiver to:
receive a signal, wherein the signal includes an intended signal sent for reception by the radio receiver and one or more interfering signals;
apply, in real-time, a first signal processing procedure to the signal to classify a corresponding type for each of the one or more interfering signals;
determine an interference mitigation scheme for each type of interfering signal;
apply, in real-time, a second signal processing procedure to the signal to mitigate the one or more interfering signals using the interference mitigation scheme for each type of interfering signal; and
output the intended signal.

19. The One or more non-transitory computer-readable media of claim 18, wherein first signal processing procedure comprises:
performing a preliminary identification of the one or more interfering signals;
performing one or more feature extraction techniques to the preliminary identification;
applying a pattern classification to features of the one or more interfering signals extracted using the one or more feature extraction techniques to yield one or more classified patterns; and
applying a trained machine learning model to the one or more classified patterns to classify the one or more interfering signals, wherein
in addition to the one or more classified patterns, one or more of the signal or cross layer sensing statistics associated with the signal are provided as additional inputs to the trained machine learning model.

20. The One or more non-transitory computer-readable media of claim 18, wherein
the corresponding type for each of the one or more interfering signals includes one of meaconing, spoofing, jamming, or chirp signal, and
the interference mitigation scheme is one of adaptive beamforming, multi-tone cancelation, and adaptive filter-based interference excision.
